(19) United States
(12) Patent Application Publication
(10) Pub. No.: US 2010/0018292 A1
(43) Pub. Date: Jan. 28, 2010

(54) METHOD FOR LEAKAGE MONITORING IN A TUBE BUNDLE REACTOR

(75) Inventors: Gerhard Olbert, Dossenheim (DE); Jobst Rüdiger von Watzdorf, Mannheim (DE); Thomas Krug, Worms (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/526,702

(22) PCT Filed: Feb. 8, 2008
(86) PCT No.: PCT/EP2008/051538

§ 371 Date: Aug. 11, 2009

(30) Foreign Application Priority Data
Feb. 12, 2007 (EP) 07102117.4

(51) Int. Cl. G01M 3/04

(52) U.S. Cl. 73/40

(57) ABSTRACT

A method is proposed for leakage monitoring in a tube bundle reactor (2) having a bundle of contact tubes (2) vertically arranged parallel to one another, through which a fluid reaction mixture is delivered, and through whose space (3) surrounding the contact tubes a liquid heat exchanger is delivered, and having one or more vent holes (4) for the liquid heat exchanger in the upper region of the tube bundle reactor (1), which connect the tube bundle reactor (1) to one or more equilibrating vessels (5, 6, 7) for the liquid heat exchanger, wherein at least one of the equilibrating vessels (5, 6, 7) for the liquid heat exchanger has a connecting line (8) for supplying the gas phase above the liquid level therein to an analysis device (9), which determines the composition of the supplied gas phase.

The invention relates to a method for leakage monitoring in tube bundle reactors and to a use of the method for carrying out gas phase reactions.

Gas phase reactions are often carried out on an industrial scale in tube bundle reactors. The conventional design of tube bundle reactors consists of a generally cylindrical container in which a bundle, i.e. a multiplicity of contact tubes, is fitted usually in a vertical arrangement. These contact tubes, which may optionally contain supported catalysts, are hermetically sealed by their ends in tube bases and open respectively into a head connected at the upper and lower ends to the container. The reaction mixture flowing through the contact tubes is supplied and discharged via these heads. A generally liquid heat exchanger circuit is fed through the space surrounding the contact tubes, in order to balance the heat budget, particularly for endothermic or exothermic reactions with elevated heat tonality.

For economic reasons, tube bundle reactors with as large a number of contact tubes as possible are used, in which case the number of fitted contact tubes may lie in the range of from 100 to 50,000, preferably between 10,000 and 50,000.

In order to prevent contamination of the fluid reaction mixture flowing through the contact tubes by the heat exchanger in the event of tube leaks, the fluid reaction mixture is usually operated at a positive pressure relative to the heat exchanger side, which is advantageously operated at atmospheric pressure, i.e. the maximum pressure on the heat exchanger side is the static pressure of the liquid head plus the pump pressure.

In the event of leaks in the regions of the tube bundle reactor through which the reaction mixture flows, in particular tube leaks, ire. in the event of damage to the tubes for example due to corrosion, open weld beads, in particular abrasion of one or more tubes at the tube base or other causes, or leaks in the tube bases, leakage takes place, fluid reaction mixture being forced in particular out of the contact tubes into the heat exchanger circuit. Owing to the high temperatures, this can lead to ignition. For example with a molten salt heat exchanger, which contains in particular potassium nitrate, the reaction gas may react fully or partially to form the breakdown products carbon monoxide and carbon dioxide; nitrogen oxides may be formed from the molten salt heat exchanger.

It was therefore an object of the invention to provide a method which ensures reliable operation of tube bundle reactors, and which registers leakages in the contact tubes promptly so that corresponding safety measures can be instigated.

The solution consists in a method for leakage monitoring in a tube bundle reactor having a bundle of contact tubes vertically arranged parallel to one another, through which a fluid reaction mixture is delivered, and through whose space surrounding the contact tubes a liquid heat exchanger is delivered, and having one or more vent holes for the liquid heat exchanger in the upper region of the tube bundle reactor, which connect the tube bundle reactor to one or more equilibrating vessels for the liquid heat exchanger, wherein at least one of the equilibrating vessels for the liquid heat exchanger has a connecting line for supplying the gas phase above the liquid level therein to an analysis device, which determines the composition of the supplied gas phase.

Tube bundle reactors are equipped with vent holes in the upper tube base or on the reactor outer wall, just below the upper tube base for the space through which the heat exchanger flows, which may for example also be corner holes. Air or inert gas is displaced through the vent holes when the reactor is being filled with the liquid heat exchanger. Owing to the design, this displaced gas accumulates primarily below the upper tube base and then flows through the vent holes and optionally a vent manifold into an equilibrating vessel, which is generally equipped with a nitrogen overhead.

During operation of the reactor, the vent holes are used to extract gas introduced into the liquid heat exchanger by the pumps, or formed therein, through the vent hole into the equilibrating vessel.

It has been found that the vent holes present in tube bundle reactors can be used for leakage monitoring, by supplying the reaction gas co-extracted with the liquid heat exchanger via the vent hole into one or more equilibrating vessels, in particular extracted from one or more contact tubes in the event of damage thereto, from the gas space of the one or more equilibrating vessels to an analysis device, which measures the concentration of thereof continuously or at predetermined intervals.

The liquid heat exchanger may preferably be a molten salt in particular, a molten salt having the eutectic composition of potassium nitrate, sodium nitrate and sodium nitrite, and have a working temperature of preferably about 250 to 450° C. When using a molten salt as the liquid heat exchanger, the one or more equilibrating vessels must be regulated to a temperature above the melting point of the molten salt in order to prevent it from solidifying. For the aforementioned preferred molten salt, this temperature is about 150 to 160° C. depending on the level of impurity.

The connecting line to the analysis device must also be heated, for example by indirect heating with steam in a double jacket, in order to prevent solidification of the molten salt.

The casing of a feed pump for the liquid heat exchanger may advantageously be used as an equilibrating vessel. In the case of a tube bundle reactor having two or more feed pumps for the liquid heat exchanger, the two or more casings of the feed pumps may correspondingly also be used as equilibrating vessels, via which a connecting line to the analysis device is provided.

In this embodiment, when evaluating the measuring results of the analysis device, it may be necessary to take into account the fact that the pump casing may be provided with a nitrogen overhead, or that lubricants of the pump may decompose and form gases which reach the analysis device.

In a particularly preferred embodiment, a buffer container is therefore provided between the tube bundle reactor and the casing of the feed pump, which serves as an equilibrating vessel, the connecting line to the analysis device being routed from the gas phase above the liquid level therein. In this case the gas spaces from the casing of the feed pump and from the equilibrating vessel are connected via an equilibrating line which is thinner compared with the connecting line to the analysis device.

Both from the buffer container and from the casing of the heat pump, it is possible to route a connecting line from its gas space to the analysis device.

Preferably, however, only the buffer container but not the casing of the feed pump has a connecting line to the analysis device.

In another embodiment, for reactors having an upper ring line and a lower ring line for supplying and discharging the liquid heat exchanger, the buffer container which has a connecting line to the analysis device is arranged in communication with the upper ring line. This embodiment allows faster and more precise detection of leakages.

For tube bundle reactors having two or more heat exchanger circuits, each with a feed pump, the gas space above the liquid level in the casings of the feed pumps may have a common connecting line to the analysis device.

In the analysis device, the concentration of breakdown products of the liquid reaction mixture may in particular be determined, particularly COₓ or residual hydrocarbons. The analysis device may in particular be an infrared and/or flame ionization detector.

The invention also relates to the use of the described method for leakage monitoring in tube bundle reactors for the production of (meth)acrolein, (meth)acrylic acid, phthalic anhydride, maleic anhydride or glyoxal.

The invention will be explained in more detail below with the aid of a drawing in which, specifically:

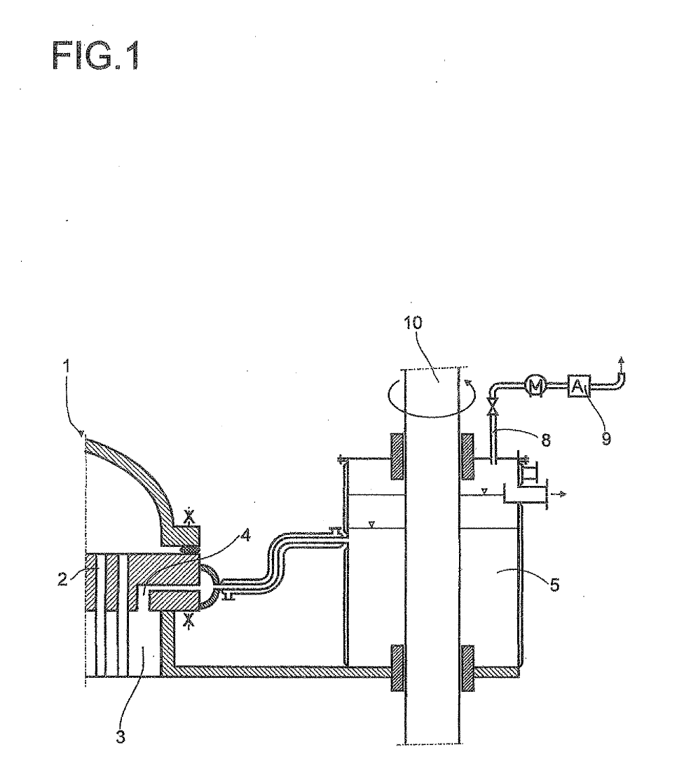

FIG. 1 shows a detail of one preferred embodiment of a tube bundle reactor for carrying out the method according to the invention,

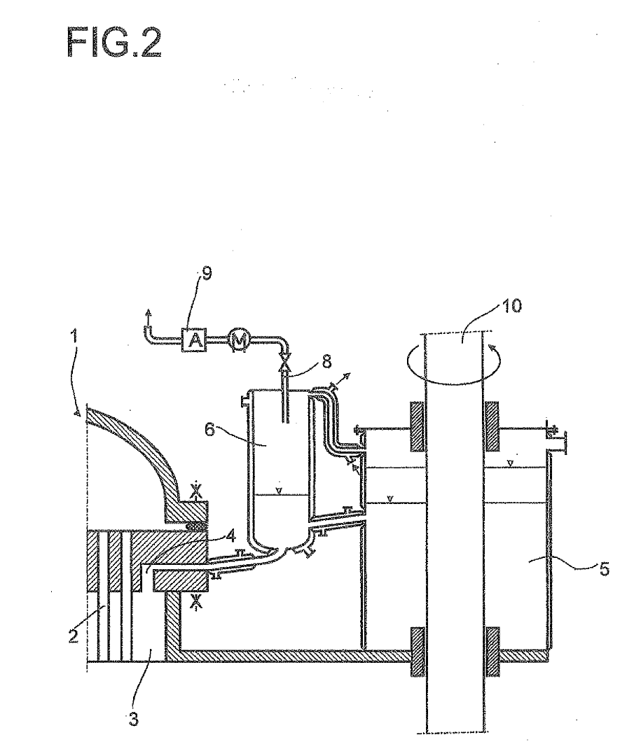

FIG. 2 shows a detail of another preferred embodiment of a tube bundle reactor for carrying out the method according to the invention,

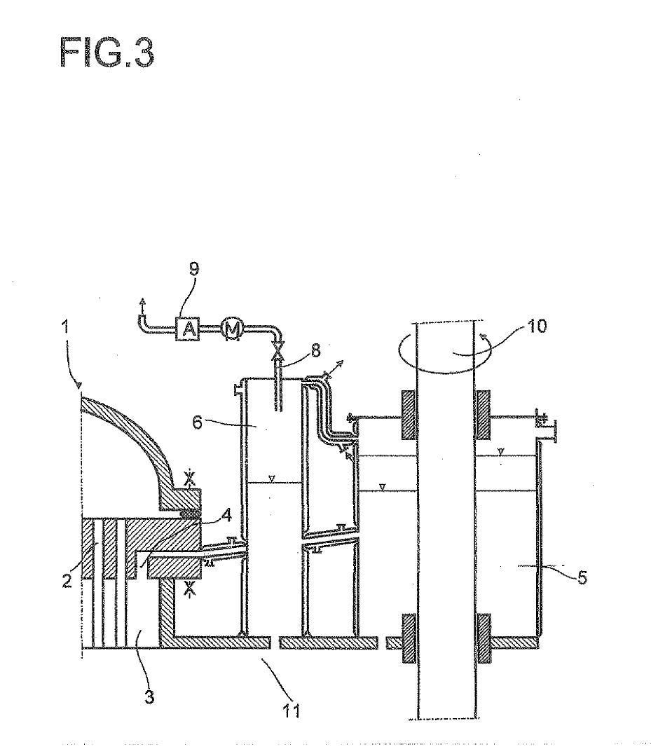

FIG. 3 shows a detail of another preferred embodiment of a tube bundle reactor for carrying out the method according to the invention,

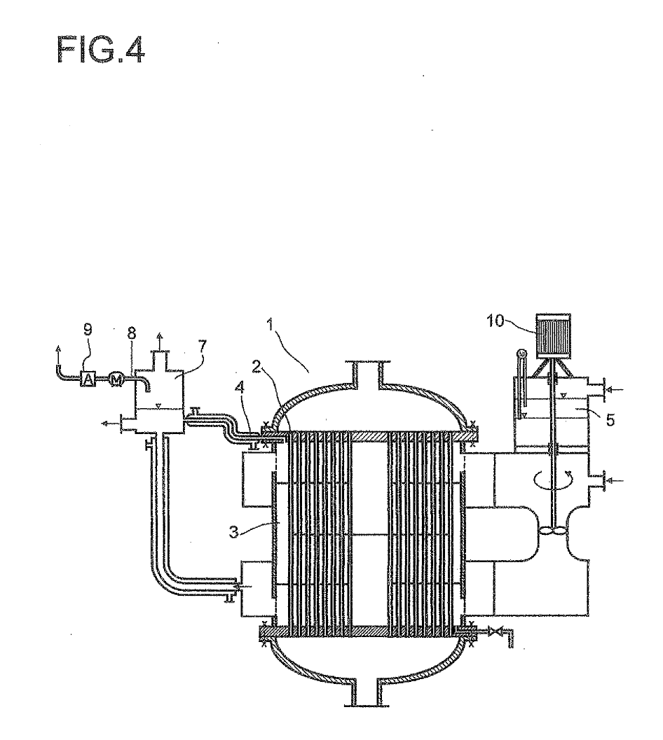

FIG. 4 shows another embodiment of a tube bundle reactor for carrying out the method according to the invention and

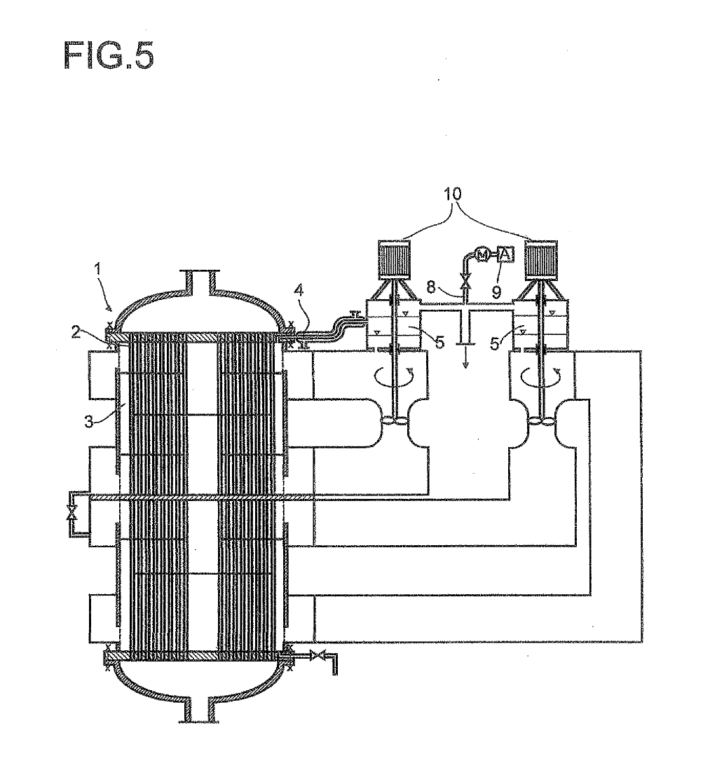

FIG. 5 shows an embodiment having two separate heat exchanger circuits for carrying out the method according to the invention.

In the figures, references which are the same denote identical or corresponding components.

The tube bundle reactor 1 represented in FIG. 1 comprises a bundle of contact tubes through which a fluid reaction mixture is delivered, with a space 3 that surrounds the contact tubes and through which a liquid heat exchanger circulates, which is delivered by a pump 10 whose pump shaft is represented in the figure. The heat exchanger space has a vent hole 4 in communication with the casing 5, which serves as an equilibrating vessel, of the feed pump 10. A connecting line 8 leads from the gas space above the liquid level in the pump casing 5 to the analysis device 9.

In the preferred embodiment represented in FIG. 2, a buffer container 6 is provided as a further equilibrating vessel between the tube bundle reactor 1 and the housing 5 of the feed pump 10. The connecting line 8 to the analysis device is used for delivering the gas phase from both equilibrating vessels, i.e. both from the casing 5 of the feed pump 10 and from the buffer container 6.

The other preferred embodiment represented in FIG. 3 shows a buffer container 6 which is arranged in communication with the upper ring line 11 for the heat exchanger.

In the embodiment represented in FIG. 4, the vent hole 4 from the contact tubes to the surrounding space 3 is connected to a further equilibrating vessel 7. The casing 5 of the feed pump 10 does not have a connection to the analysis device 9.

FIG. 5 shows an embodiment with two separate heat exchanger circuits, it each having a feed pump 10 with the pump casing 5 as an equilibrating vessel. The connecting line 8 to the analysis device 9 connects the gas space above the liquid level in both casings 5 of the feed pumps 10.

1.-11. (canceled)

12. A method for leakage monitoring in a tube bundle reactor, the method comprising:
delivering a reaction mixture through a plurality of contact tubes of the tube bundle reactor, the contact tubes being arranged vertically and parallel to one another;
delivering a liquid heat exchanger into space surrounding the contact tubes within the tube bundle reactor;
venting the liquid heat exchanger through one or more vent holes disposed in an upper region of the tube bundle reactor, the vent holes connecting the tube bundle reactor to one or more equilibrating vessels, wherein one of the equilibrating vessels comprises a casing of a feed pump for the liquid heat exchanger;
supplying a gas phase within at least one equilibrating vessel to an analysis device, the gas phase sitting above the liquid heat exchanger within the at least one equilibrating vessel; and
determining a composition of the supplied gas phase with the analysis device.

13. The method as claimed in claim 12, wherein the liquid heat exchanger is a molten salt.

14. The method as claimed in claim 13, wherein the molten salt is a eutectic mixture of sodium nitrate, potassium nitrate, and sodium nitrite.

15. The method as claimed in claim 12, wherein one of the equilibrating vessels comprises a buffer container disposed between the tube bundle reactor and the casing of the feed pump.

16. The method as claimed in claim 15, wherein the buffer container, but not the casing of the feed pump, supplies the gas phase to the analysis device.

17. The method as claimed in claim 16, wherein the tube bundle reactor includes an upper ring line and a lower ring line for respectively supplying and discharging the liquid heat exchanger, and wherein the vent holes are disposed within the upper ring line.

18. The method as claimed in claim 12, wherein two or more of the equilibrating vessels comprise casings of feed pumps included as part of two or more separate heat exchanger circuits, and the casings supply the gas phase through a common connecting line to the analysis device.

19. The method as claimed in claim 12, wherein determining the composition of the supplied gas phase includes continuously determining the composition of the supplied gas phase with the analysis device.

20. The method as claimed in claim 12, wherein determining the composition of the supplied gas phase with the analysis device includes measuring a concentration of breakdown products of the fluid reaction mixture.

21. The method as claimed in claim 20, wherein the breakdown products of the fluid reaction mixture are COₓ, NOₓ or residual hydrocarbons, and wherein the analysis device comprises at least one of an infrared and a flame ionization detector.

22. The method as claimed in claim 12, further comprising producing one of (meth)acrolein, (meth)acrylic acid, phthalic anhydride, maleic anhydride, and glyoxal with the tube bundle reactor.
